(19) United States
(12) Patent Application Publication
(10) Pub. No.: US 2026/0353030 A1
(43) Pub. Date: Nov. 5, 2026

(54) INFORMATION PROCESSING APPARATUS, METHOD, AND PROGRAM

(71) Applicant: SONY GROUP CORPORATION, Tokyo (JP)

(72) Inventor: Minoru TSUJI, Chiba (JP)

(73) Assignee: SONY GROUP CORPORATION, Tokyo (JP)

(21) Appl. No.: 19/474,431

(22) PCT Filed: Aug. 8, 2023
(86) PCT No.: PCT/JP2023/028857

§ 371 Date: Oct. 10, 2025

Related U.S. Application Data
(60) Provisional application No. 63/499,293, filed on May 1, 2023.

(51) Int. Cl. H04S 7/00

(52) U.S. Cl. CPC H04S 7/308; H04S 7/302; H04S 2400/11; H04S 2400/13

(57) ABSTRACT

The present technology relates to an information processing apparatus, method, and program that enable data sharing between different spatial audio schemes. An information processing apparatus includes an acquisition unit that acquires speaker layout information at a time of reproduction of audio data in a first data format, and a position data generation unit that converts first position data of a sound source in the first data format or second position data of the sound source in a second data format in which a rendering scheme at the time of reproduction is different from the first data format into the second position data or the first position data on the basis of the speaker layout information. The present technology can be applied to a metadata conversion device.

### TECHNICAL FIELD

The present technology relates to an information processing apparatus, method, and program, and more particularly, to an information processing apparatus, method, and program that enable data sharing between different spatial audio schemes.

### BACKGROUND ART

In recent years, object-based audio technology has attracted attention.

In object-based audio, audio data is constituted by waveform data for an object and metadata indicating localization information of sound of the object based on the waveform data, and rendering to a desired number of channels is performed on the basis of the metadata at the time of reproduction.

There are several schemes for a data format and a rendering scheme of the audio data of the object-based audio.

One is a data format called Moving Picture Experts Group (MPEG)-H 3D Audio (see, for example, Non-Patent Document 1).

In the MPEG-H 3D Audio, localization information is positional information in a polar coordinate format indicating a direction of an object with a listening point (listening position) as a reference, and rendering is performed by a rendering scheme called Vector Based Amplitude Panning (VBAP) (see, for example, Non-Patent Document 2) on the basis of the positional information.

On the other hand, there is a data format called AC-4 (see, for example, Non-Patent Document 3).

In the AC-4, localization information is positional information in an absolute coordinate format indicating a position in an xyz space, and rendering is performed by calculating a gain ratio of each speaker from a ratio of distances in directions of an x-axis, a y-axis, and a z-axis between an object and a speaker on the basis of the positional information.

With respect to these data formats, more specifically, the rendering scheme, the former is called an Egocentric scheme, and the latter is called an Allocentric scheme from features.

### CITATION LIST

### Non-Patent Document

Non-Patent Document 1: ISO/IEC 23008-3 Information technology—High efficiency coding and media delivery in heterogeneous environments—Part 3: 3D audio
Non-Patent Document 2: Ville Pulkki, “Virtual Sound Source Positioning Using Vector Base Amplitude Panning”, Journal of AES, vol. 45, no. 6, pp. 456-466, 1997
Non-Patent Document 3: ETSI TS 103 448 V1.1.1(2016-09) “AC-4 Object Audio Renderer for Consumer Use”
Non-Patent Document 4: Recommendation ITU-R BS.2051-3(05/2022) “Advanced sound system for programme production”

### SUMMARY OF THE INVENTION

### Problems to be Solved by the Invention

Incidentally, it is desired that the audio data including the waveform data and the metadata can be shared between both the formats.

Here, for example, it is considered that the audio data of the Allocentric scheme is converted into the audio data of the Egocentric scheme.

In this case, it is conceivable to convert values of an x-coordinate, a y-coordinate, and a z-coordinate, which are the localization information in the absolute coordinate format included in the metadata, into values of Azimuth (horizontal angle), Elevation (vertical angle), and Radius (radius) in the polar coordinate format with the listening position with a reference on the basis of the physical law.

However, since the rendering scheme is different between the pieces of audio data before and after the conversion, the same localization sensation of sound cannot be obtained at the time of reproduction only by simply converting the localization information as described above.

A specific example will be described.

For example, in the Allocentric scheme, there is an object at a position of coordinates (x, y, z)=(−1, 1, 0), and sound of the object is reproduced in a speaker layout of 7.1.4ch.

In this case, in a case where the rendering method in the AC-4, that is, the rendering of the Allocentric scheme is performed, the sound of the object is reproduced from a speaker of “Left” with a gain ratio of 1.0. That is, the sound of the object is output only from one speaker “Left”.

In the Allocentric scheme, in a case where a position of the speaker “Left” is “M+030” defined by International Telecommunication Union-Radiocommunication Sector Broadcasting service (ITU-R BS).2051 (see, for example, Non-Patent Document 4), a position of +30 degrees is set as a reference, and a position from +30 degrees to +45 degrees is set as an allowable range. Here, a front direction from a reference position is set to 0 degrees, and a counterclockwise direction is set to a positive direction.

Accordingly, in a case where the speaker “Left” is arranged at the position of +30 degrees, a sound image of the object is localized at the position of +30 degrees, but in a case where the speaker “Left” is arranged at a position of +45 degrees, the sound image of the object is localized at the position of +45 degrees.

Here, the waveform data and the metadata of the Allocentric scheme in the above example are converted into data of the Egocentric scheme and are reproduced. Note that, hereinafter, the coordinates (Azimuth, Elevation, Radius) in the polar coordinate format are also referred to as (Az, El, Rad).

When the localization information (positional information) is simply converted on the basis of the physical law, the coordinates (x, y, z)=(−1, 1, 0) indicating the position of the object are converted into polar coordinates (Az, El, Rad)=(+45, 0, 1.414) by a function represented in the following Expression (1).

$$\begin{matrix}[ Math . 1 ] & \\ Az = atan 2 ( - x , y ) * \frac{180}{π} & ( 1 )\end{matrix}$$

$$El = atan 2 ( z , \sqrt{{x}^{2} + {y}^{2}} ) * \frac{180}{π}$$

$$Rad = \sqrt{{x}^{2} + {y}^{2} + {z}^{2}}$$

In the Egocentric scheme, for example, in a case where reproduction is performed with a speaker layout of 7.1.4ch that is the same as the Allocentric scheme, a sound image of the object rendered by VBAP on the basis of the polar coordinates (+45, 0, 1.414) that is the localization information obtained by the conversion is localized at the position of +45 degrees regardless of an actual position of the speaker.

Therefore, when an original content is produced by the Allocentric scheme in an environment where the speaker “Left” is arranged at the position of +30 degrees, the localization of the sound greatly changes.

That is, when the localization information in the absolute coordinate format is simply converted into the localization information in the polar coordinate format on the basis of the physical law, the object produced as the object localized at the position of +30 degrees is localized at the position of +45 degrees, and the localization position of the sound greatly changes.

From the above, it has been difficult to perform data sharing of audio data while maintaining localization of sound between data formats of different spatial audio schemes, that is, data formats of different rendering schemes.

The present technology has been made in view of such a situation, and enables data sharing between different spatial audio schemes.

### Solutions to Problems

An information processing apparatus according to one aspect of the present technology includes an acquisition unit that acquires speaker layout information at a time of reproduction of audio data in a first data format, and a position data generation unit that converts first position data of a sound source in the first data format or second position data of the sound source in a second data format in which a rendering scheme at the time of reproduction is different from the first data format into the second position data or the first position data on the basis of the speaker layout information.

An information processing method or program according to an aspect of the present technology includes a step of acquiring speaker layout information at a time of reproduction of audio data in a first data format, and a step of converting first position data of a sound source in the first data format or second position data of the sound source in a second data format in which a rendering scheme at the time of reproduction is different from the first data format into the second position data or the first position data, on the basis of the speaker layout information.

In one aspect of the present technology, the speaker layout information at the time of reproduction of the audio data in the first data format is acquired, and the first position data of the sound source in the first data format or the second position data of the sound source in the second data format in which the rendering scheme at the time of reproduction is different from the first data format is converted into the second position data or the first position data on the basis of the speaker layout information.

### BRIEF DESCRIPTION OF DRAWINGS

FIG. 1 is a diagram illustrating a configuration example of a metadata conversion device.

FIG. 2 is a diagram illustrating a configuration example of a sound image localization estimation unit.

FIG. 3 is a flowchart for explaining metadata conversion processing.

FIG. 4 is a diagram illustrating an example of speaker layout information.

FIG. 5 is a diagram for explaining an absolute coordinate space.

FIG. 6 is a diagram illustrating an example of a calculated panning gain value.

FIG. 7 is a diagram for explaining a speaker vector.

FIG. 8 is a diagram for explaining a combined vector.

FIG. 9 is a flowchart for explaining metadata conversion processing.

FIG. 10 is a diagram illustrating a display screen example of an object metadata conversion application.

FIG. 11 is a diagram illustrating a configuration example of a reproduction device.

FIG. 12 is a diagram illustrating a configuration example of a metadata conversion device.

FIG. 13 is a flowchart for explaining metadata conversion processing.

FIG. 14 is a diagram illustrating a configuration example of a computer.

### MODE FOR CARRYING OUT THE INVENTION

Embodiments to which the present technology is applied will be described hereinafter with reference to the drawings.

### First Embodiment

### <Configuration Example of Metadata Conversion Device>

The present technology converts object metadata of a predetermined spatial audio scheme, that is, in a predetermined data format into object metadata in another data format of a different rendering scheme by using speaker layout information, and enables data sharing between different spatial audio schemes.

For example, in the present technology, a localization direction (localization position) of sound of a sound source by a rendering scheme in a data format before conversion (spatial audio scheme) is estimated. Then, on the basis of an estimation result, positional information at which the sound is localized in the estimated direction by a rendering scheme in a data format after conversion is determined, and the positional information is used as position data in the object metadata in the data format after conversion.

Furthermore, in the present technology, for example, in a case where the rendering schemed in the data format before conversion is an Allocentric scheme, a localization direction of sound in the Allocentric scheme is estimated by synthesis of vectors including a direction of a speaker to which a gain is allocated and a magnitude of a gain value.

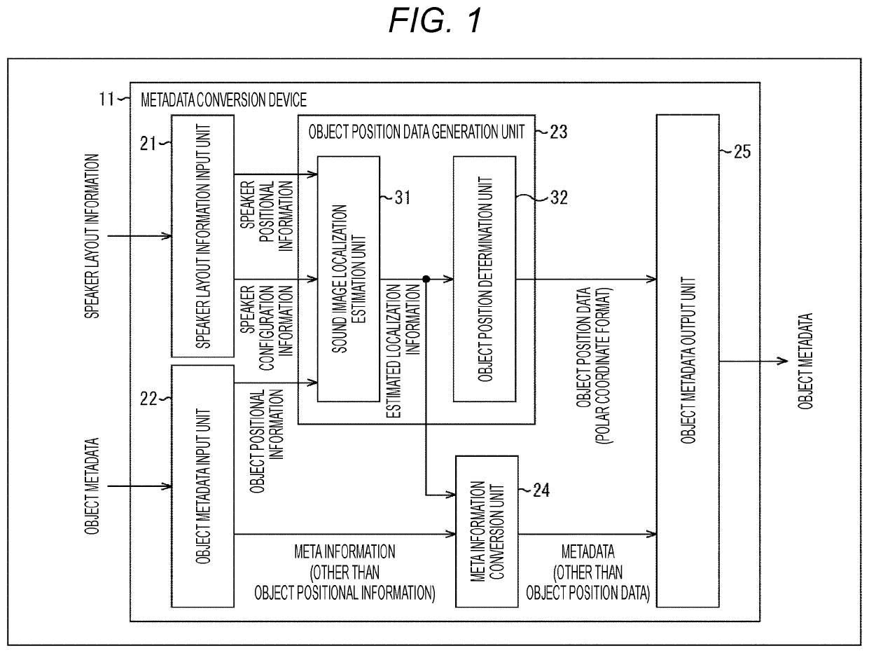

FIG. 1 is a diagram illustrating a configuration example of an embodiment of a metadata conversion device to which the present technology is applied.

A metadata conversion device 11 illustrated in FIG. 1 converts object metadata in a data format in which a rendering scheme is an Allocentric scheme such as AC-4 into object metadata in a data format in which a rendering scheme is an Egocentric scheme such as MPEG-H 3D Audio.

Audio data in a data format of the Allocentric scheme, that is, a data format in which the rendering scheme is the Allocentric scheme includes waveform data that is an audio signal for reproducing sound of one or each of a plurality of objects and object metadata of each object. Note that, the audio data may include waveform data (audio signal) every channel.

The object metadata includes at least object position data indicating a localization position of sound of the object, that is, a position of the object.

In particular, in the object metadata of the Allocentric scheme, the object position data is data in an absolute coordinate format indicating an absolute position of an object in a virtual space. Specifically, the object position data is absolute coordinates (x, y, z) indicating a position on an absolute coordinate space (xyz space) in which the object is arranged.

Furthermore, the object metadata appropriately includes, for example, name information indicating a name (object name) of the object, type information indicating a type of the object such as a vocal or a guitar, size information indicating a size of the object, priority information indicating a priority of the object, spread information indicating a degree of spread the object, gain information indicating a gain value of the object, and the like. Here, for example, a preset name or value may be used for each piece of object metadata, or the object metadata may be appropriately changeable by a user. For example, in the priority information, values of 0 to 7 may be used, a priority of 7 may be set to an object with a highest priority, and a priority of 0 may be set to an object with a lowest priority. Furthermore, in real-time processing, the name and value of each piece of object metadata may be dynamically changed.

By contrast, the audio data in the data format of the Egocentric scheme, that is, in the data format in which the rendering scheme is the Egocentric scheme includes waveform data of one or each of a plurality of objects and object metadata of each object. Note that, the audio data may include waveform data every channel.

The object metadata of the Egocentric scheme includes at least object position data indicating the position of the object similarly to the case of the Allocentric scheme.

However, in the object metadata of the Egocentric scheme, the object position data is data in a polar coordinate format indicating a relative position of the object viewed from a listening position (listening point) serving as a reference in the virtual space. Specifically, the object position data is polar coordinates (Az, El, Rad) indicating the relative position of the object viewed from the listening position.

Furthermore, the object metadata of the Egocentric scheme also includes name information, type information, size information, priority information, spread information, gain information, and the like of the object as appropriate.

As described above, in the audio data of the Allocentric scheme and the audio data of the Egocentric scheme, the waveform data of the object is the same, but the rendering scheme and the coordinate format of the object position data are different.

The metadata conversion device 11 includes a speaker layout information input unit 21, an object metadata input unit 22, an object position data generation unit 23, a meta information conversion unit 24, and an object metadata output unit 25.

The speaker layout information input unit 21 functions as an acquisition unit that acquires speaker layout information from an outside of the metadata conversion device 11.

The speaker layout information acquired by the speaker layout information input unit 21 is information regarding a speaker system when audio data of the Allocentric scheme as a conversion target is reproduced, that is, when reproduction is performed by the Allocentric scheme.

For example, the speaker layout information is information indicating the number of speakers constituting the speaker system used when reproduction is performed by the Allocentric scheme, that is, the number of channels, a channel configuration, an arrangement position of speakers, and the like.

The speaker layout information input unit 21 extracts speaker positional information indicating the arrangement position of each speaker and speaker configuration information indicating a speaker configuration of the speaker system such as the number of channels and the channel configuration from the acquired speaker layout information, and supplies the extracted information to the object position data generation unit 23.

The object metadata input unit 22 acquires object metadata of the Allocentric scheme from the outside of the metadata conversion device 11.

The object metadata input unit 22 extracts the object position data included in the acquired object metadata, as object positional information indicating the position of the object, and supplies the object positional information to the object position data generation unit 23.

Furthermore, the object metadata input unit 22 extracts data other than the object position data (object positional information) included in the acquired object metadata, as meta information, and supplies the meta information to the meta information conversion unit 24.

For example, the meta information is name information, type information, size information, priority information, spread information, gain information, or the like.

The object position data generation unit 23 generates object position data indicating the position of the object at the time of reproduction by the Egocentric scheme on the basis of the speaker positional information, the speaker configuration information, and the object positional information, and supplies the object position data to the object metadata output unit 25. In other words, the object position data generation unit 23 converts the object position data of the Allocentric scheme into the object position data of the Egocentric scheme.

The object position data generated by the object position data generation unit 23 is position data in a polar coordinate format that is stored in the object metadata of the Egocentric scheme and indicates the relative position of the object with the listening position as a reference.

The object position data generation unit 23 includes a sound image localization estimation unit 31 and an object position determination unit 32.

The sound image localization estimation unit 31 generates estimated localization information on the basis of the speaker positional information and the speaker configuration information supplied from the speaker layout information input unit 21 and the object positional information supplied from the object metadata input unit 22, and supplies the estimated localization information to the object position determination unit 32 and the meta information conversion unit 24.

The estimated localization information is information indicating an estimation result of the localization position of the sound of the object, that is, the localization position of the sound image when the sound of the object is reproduced on the basis of the audio data of the Allocentric scheme in a speaker layout indicated by the speaker layout information. More specifically, the estimated localization information is information indicating an estimation result of a direction in which the sound of the object is localized when rendering is performed by the Allocentric scheme and the sound of the object is reproduced.

The object position determination unit 32 generates the object position data in the polar coordinate format on the basis of the estimated localization information supplied from the sound image localization estimation unit 31, and supplies the object position data to the object metadata output unit 25.

The object position data in the polar coordinate format is the object position data of the Egocentric scheme when the position indicated by the estimated localization information is the position of the object.

The meta information conversion unit 24 appropriately converts the meta information supplied from the object metadata input unit 22 on the basis of the estimated localization information supplied from the sound image localization estimation unit 31, and supplies metadata obtained by the conversion to the object metadata output unit 25.

The meta information conversion unit 24 converts meta information of the Allocentric scheme into meta information of the Egocentric scheme, and outputs the meta information after conversion as the metadata.

The object metadata output unit 25 outputs data including the object position data in the polar coordinate format supplied from the object position determination unit 32 and the metadata supplied from the meta information conversion unit 24, as the object metadata of the Egocentric scheme.

### <Configuration Example of Sound Image Localization Estimation Unit>

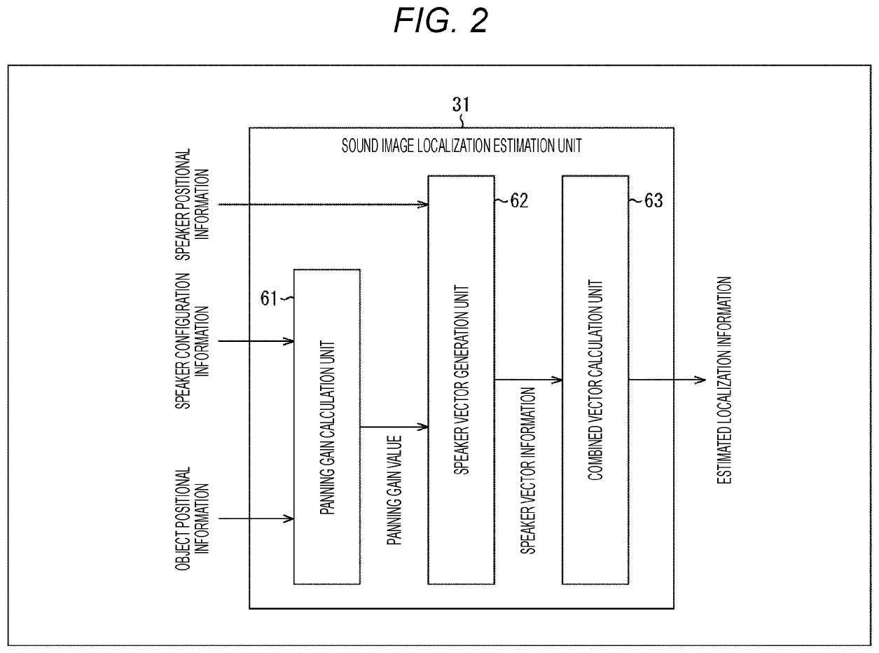

Furthermore, the sound image localization estimation unit 31 has a configuration illustrated in FIG. 2, for example.

The sound image localization estimation unit 31 includes a panning gain calculation unit 61, a speaker vector generation unit 62, and a combined vector calculation unit 63.

The panning gain calculation unit 61 calculates a panning gain value on the basis of the speaker configuration information supplied from the speaker layout information input unit 21 and the object positional information supplied from the object metadata input unit 22, and supplies the panning gain value to the speaker vector generation unit 62.

The panning gain calculation unit 61 calculates, as the panning gain value, a gain value allocated to each speaker when the sound of the object is reproduced on the basis of the audio data of the Allocentric scheme in the speaker layout indicated by the speaker configuration information.

For example, at the time of reproduction by the Allocentric scheme, the panning gain value is calculated every speaker, that is, every channel, on the basis of the rendering method of the Allocentric scheme, and the waveform data of the object is multiplied by the panning gain value to perform gain adjustment. Then, the gain-adjusted waveform data is supplied to a speaker corresponding to the channel, and a sound based on the waveform data is output from the speaker.

The panning gain calculation unit 61 outputs the panning gain value of each speaker calculated on the basis of the rendering method of the Allocentric scheme, as a gain value for speaker vector generation.

The panning gain value is a gain value that is allocated to each speaker in the Allocentric scheme when the sound of the object is reproduced on the basis of the audio data of the Allocentric scheme.

The speaker vector generation unit 62 generates a vector (hereinafter, also referred to as a speaker vector) every speaker on the basis of the speaker positional information supplied from the speaker layout information input unit 21 and the panning gain value supplied from the panning gain calculation unit 61.

For example, the speaker vector generation unit 62 generates a speaker vector in which a direction indicating a position of the speaker indicated by the speaker positional information is an orientation of the vector and the panning gain value is a magnitude of the vector. That is, a vector having a magnitude of the panning gain value and facing the direction of the position of the speaker indicated by the speaker positional information is a speaker vector.

The speaker vector generation unit 62 supplies information including the speaker vector of each speaker to the combined vector calculation unit 63, as speaker vector information.

The combined vector calculation unit 63 combines speaker vectors of a plurality of speakers on the basis of the speaker vector information supplied from the speaker vector generation unit 62, and supplies the resultant combined vector to the object position determination unit 32 and the meta information conversion unit 24, as estimated localization information.

### <Description of Metadata Conversion Processing>

Next, an operation of the metadata conversion device 11 will be described.

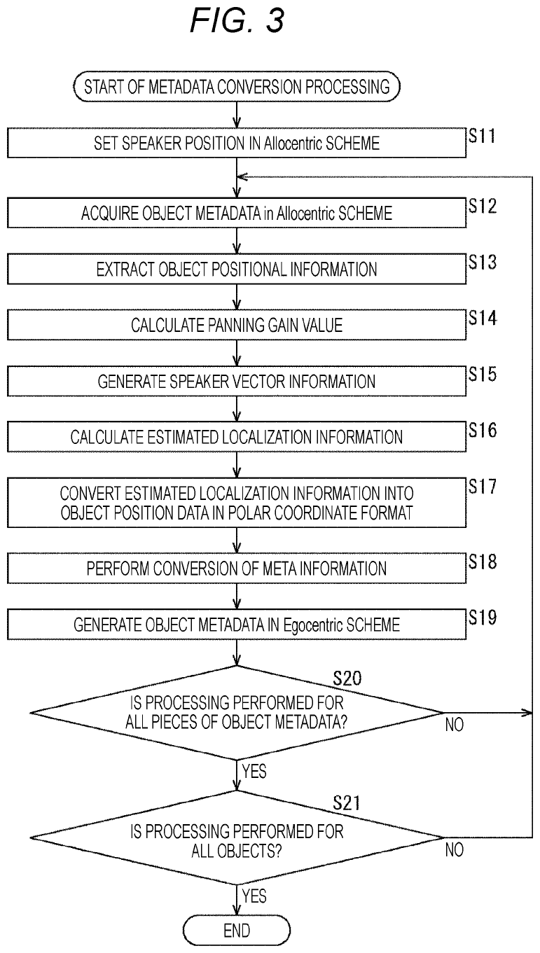

That is, metadata conversion processing by the metadata conversion device 11 will be described below with reference to the flowchart of FIG. 3. This metadata conversion processing is started, for example, when the user designates audio data of the Allocentric scheme as the conversion target.

In step S11, the speaker layout information input unit 21 sets a speaker position of the Allocentric scheme in accordance with a user's operation or the like.

For example, in the conversion of the audio data, that is, the object metadata, the user designates the speaker configuration such as the channel configuration and the number of channels of the speaker system when audio reproduction is performed by the Allocentric scheme, the arrangement position of each speaker, and the like. That is, information regarding the speaker system used for reproduction by the Allocentric scheme is designated.

Then, the speaker layout information input unit 21 sets the arrangement position and the like of the speaker in accordance with a designation operation of the user, and obtains speaker layout information indicating a setting result.

The speaker layout information input unit 21 extracts the speaker positional information and the speaker configuration information from the acquired speaker layout information, supplies the speaker positional information to the speaker vector generation unit 62, and supplies the speaker configuration information to the panning gain calculation unit 61.

Ideally, the speaker configuration and the arrangement position indicated by the speaker layout information are the speaker configuration and the arrangement position when a content creator determines the object position data included in the object metadata of the Allocentric scheme.

Accordingly, in a case where the speaker configuration and the like at the time of determining the object position data can be specified, the speaker configuration and the like are only required to be set (designated). By contrast, in a case where the speaker configuration and the like at the time of determining the object position data cannot be specified, for example, a standard speaker configuration and the like at the time of reproduction by the Allocentric scheme are only required to be set.

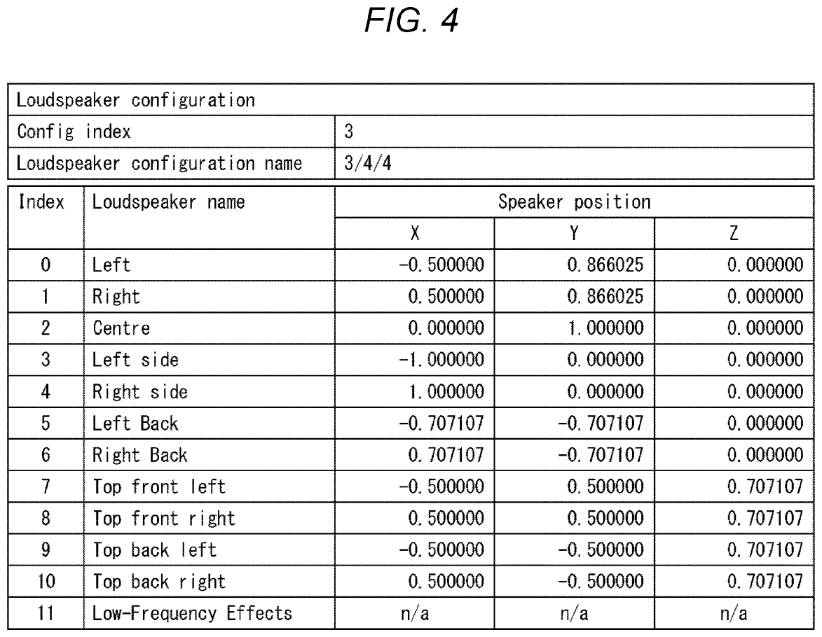

As a specific example, for example, in a case where the speaker layout of the speaker system used for reproduction by the Allocentric scheme is 7.1.4ch, the information illustrated in FIG. 4 is acquired as the speaker layout information.

In FIG. 4, “3/4/4” described in a field of “Loudspeaker configuration name” indicates the speaker configuration. In particular, “3/4/4” indicates a speaker configuration in which three speakers are arranged on a front side, a total of four speakers are arranged in surroundings, that is, side and back sides, and four speakers are arranged in an upper layer.

Furthermore, “Loudspeaker name” indicates a name of each speaker, and “Index” indicates an index for uniquely identifying each speaker. Moreover, “Speaker position” is speaker positional information indicating an absolute arrangement position of each speaker in the xyz space.

In this example, the speaker positional information is described in an absolute coordinate format. That is, the speaker positional information is absolute coordinates (x, y, z) indicating a position of the speaker in the absolute coordinate space (xyz space).

The speaker layout information input unit 21 extracts “Speaker position”, as the speaker positional information, and extracts “Loudspeaker configuration name”, as the speaker configuration information. Note that, “Loudspeaker name” and “Index” may also be extracted as pieces of information constituting the speaker configuration information. The speaker configuration information is information required for rendering by the Allocentric scheme.

Referring back to the description of the flowchart of FIG. 3, in step S12, the object metadata input unit 22 acquires the object metadata of the Allocentric scheme from the audio data designated by the user.

For example, the metadata conversion device 11 sequentially selects each object as an object of a processing target for a content reproduced by the audio data. Furthermore, in the content, object metadata is prepared every predetermined period such as one or a plurality of frames, and each period is sequentially selected as a period as a processing target in the metadata conversion device 11.

In step S12, the object metadata input unit 22 acquires the object metadata in the period as the processing target of the object as the processing target.

In step S13, the object metadata input unit 22 extracts the object positional information from the acquired object metadata of the Allocentric scheme, and supplies the object positional information to the panning gain calculation unit 61.

As described above, the object metadata of the Allocentric scheme includes the object position data in the absolute coordinate format, and the object position data is extracted as the object positional information in step S13.

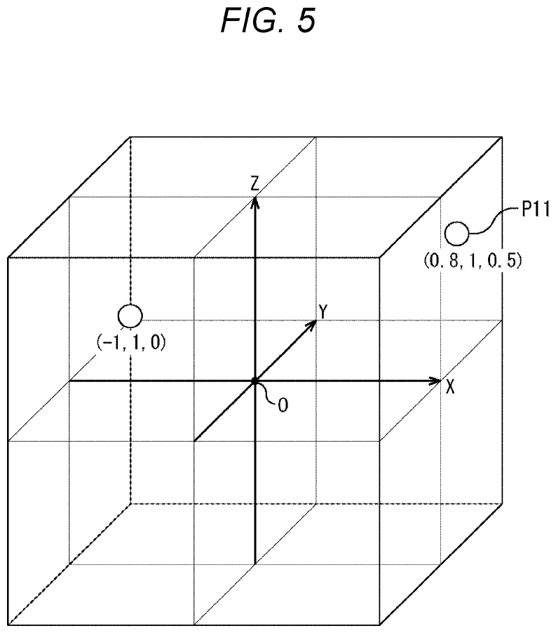

For example, as illustrated in FIG. 5, it is assumed that there is the absolute coordinate space (xyz space) with the listening position as an origin O. In this example, in the absolute coordinate space, a right direction in the drawing is a positive direction of an x-axis, a depth direction in the drawing is a positive direction of a y-axis, and an upper direction in the drawing is a positive direction of a z-axis.

In such an absolute coordinate space, for example, when one object is arranged at a position P11, absolute coordinates (x, y, z)=(0.8, 1, 0.5) indicating the absolute position of the position P11 in the absolute coordinate space is set as the object position data of the object arranged at the position P11.

Furthermore, the object metadata input unit 22 extracts data other than the object position data included in the object metadata of the Allocentric scheme, as the meta information, and supplies the meta information to the meta information conversion unit 24.

Here, for example, the name information, the type information, the size information, the priority information, the spread information, the gain information, and the like of the object are extracted as the meta information.

Referring back to the description of FIG. 3, in step S14, the panning gain calculation unit 61 calculates the panning gain value on the basis of the speaker configuration information supplied from the speaker layout information input unit 21 and the object positional information supplied from the object metadata input unit 22.

For example, the panning gain calculation unit 61 calculates the panning gain value every the plurality of speakers indicated by the speaker configuration information for the object as the processing target on the basis of a rendering method (see, for example, Non-Patent Document 3 described above) defined by the AC-4 (Allocentric scheme).

In this case, the gain value every direction is obtained for each speaker by obtaining a ratio of a distance between the object and each of the plurality of speakers every direction of an x-axis direction, a y-axis direction, and a z-axis direction. Then, the product of the gain values every direction obtained for the speaker is set as the panning gain value of the speaker.

The panning gain calculation unit 61 supplies the calculated panning gain values of the plurality of speakers to the speaker vector generation unit 62.

As a specific example, for example, as illustrated in FIG. 5, it is assumed that the object positional information, that is, the absolute coordinates (x, y, z) of the position of the object as the processing target are (0.8, 1, 0.5), and the speaker configuration indicated by the speaker configuration information is the configuration (7.1.4ch) illustrated in FIG. 4.

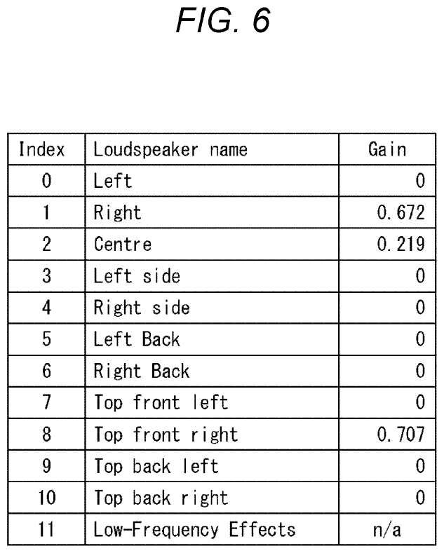

In such a case, the calculation result illustrated in FIG. 6 is obtained as the panning gain value of each speaker. In the example of FIG. 6, panning gain values of speakers “Right”, “Centre”, and “Top front right” in the vicinity of the object as the processing target are values other than 0, and panning gain values of the other speakers are 0.

In step S15, the speaker vector generation unit 62 generates speaker vector information on the basis of the speaker positional information supplied from the speaker layout information input unit 21 and the panning gain value supplied from the panning gain calculation unit 61.

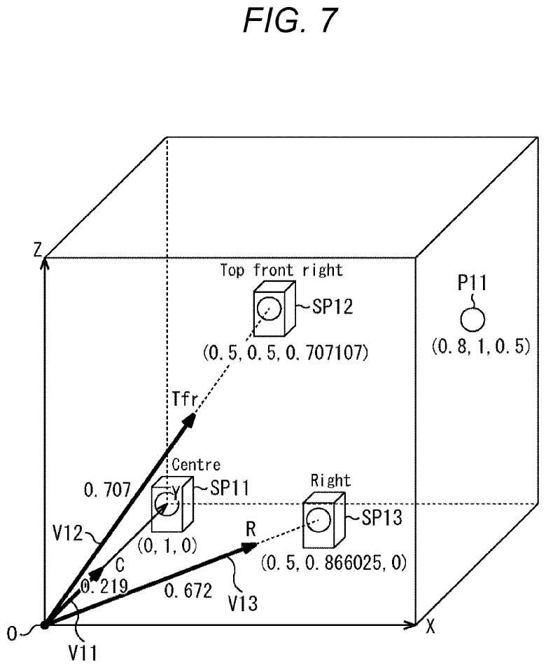

For example, in a case where the panning gain value illustrated in FIG. 6 is obtained, the speaker vector generation unit 62 generates the speaker vector illustrated in FIG. 7. Note that, in FIG. 7, portions corresponding to those in FIG. 5 are denoted by the same reference signs, and the description thereof will be omitted.

In the example of FIG. 7, a speaker SP11, a speaker SP12, and a speaker SP13 arranged on the absolute coordinate space (xyz space) represent the speaker “Centre”, the speaker “Top front right”, and the speaker “Right”, respectively. Furthermore, the absolute coordinates (x, y, z) as the speaker positional information are written in the vicinity of the speakers.

For example, focusing on the speaker SP11 (Centre), a speaker vector C of the speaker SP11 is obtained from the speaker positional information illustrated in FIG. 4, that is, absolute coordinates (x, y, z)=(0, 1, 0) of a position of the speaker SP11 and a panning gain value “0.219” of the speaker SP11 illustrated in FIG. 6.

Specifically, a vector represented by an arrow V11 of which an orientation is a direction from the origin O toward the speaker SP11 and of which a magnitude is the panning gain value “0.219” is calculated as the speaker vector C of the speaker “Centre”.

Similarly, a vector represented by an arrow V12 having a direction from the origin O toward the speaker SP12 (absolute coordinates (0.5, 0.5, 0.707107)) and having a magnitude of a panning gain value “0.707” is calculated as a speaker vector Tfr of the speaker “Top front right”.

Furthermore, a vector represented by an arrow V13 having a direction from the origin O toward the speaker SP13 (absolute coordinates (0.5, 0.866025, 0)) and having a magnitude of a panning gain value “0.672” is calculated as a speaker vector R of the speaker “Right”.

The speaker vector C, the speaker vector Tfr, and the speaker vector R can be obtained by calculating the following Expression (2). That is, the speaker vector generation unit 62 obtains the speaker vectors by calculating Expression (2) on the basis of the speaker positional information and the panning gain value.

[Math. 2]

R=(0.5,0.866025,0)×0.672=(0.336,0.582,0)

C=(0,1,0)×0.219=(0,0.219,0)

Tfr=(0.5,0.5,0.707107)×0.707=(0.354,0.354,0.500) (2)

Note that, in step S15, the speaker vectors are calculated for all the speakers constituting the speaker system having the speaker configuration indicated by the speaker layout information. In particular, in the example illustrated in FIG. 7, speaker vectors of speakers other than the speakers “Right”, “Centre”, and “Top front right” are zero vectors.

The speaker vector generation unit 62 supplies information including the speaker vector of each speaker to the combined vector calculation unit 63, as the speaker vector information.

Referring back to the description of the flowchart of FIG. 3, in step S16, the combined vector calculation unit 63 calculates the estimated localization information on the basis of the speaker vector information supplied from the speaker vector generation unit 62.

Specifically, the combined vector calculation unit 63 generates the combined vector by combining the speaker vectors for all the speakers indicated by the speaker vector information, and uses the combined vector, that is, the coordinates of the position indicated by the combined vector, as the estimated localization information.

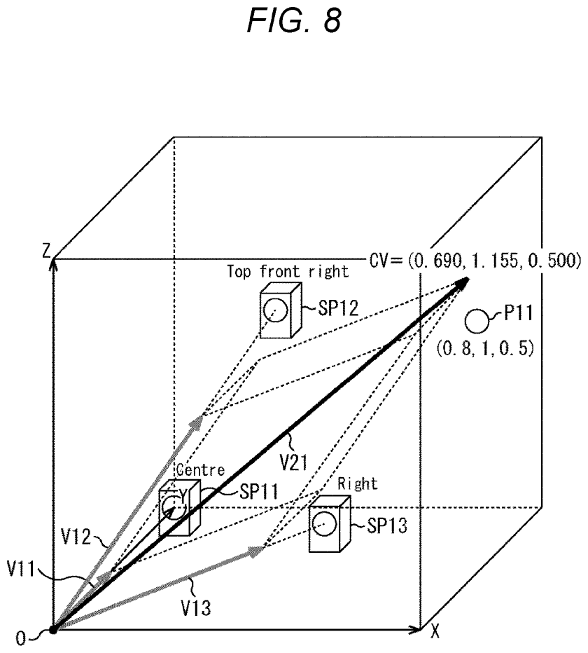

For example, in a case where the speaker vector illustrated in FIG. 7 is obtained, the speaker vector C that is not the zero vector, the speaker vector Tfr, and the speaker vector R are combined as illustrated in FIG. 8, and a combined vector CV is generated (calculated). Note that, in FIG. 8, portions corresponding to those in the case of FIG. 7 are denoted by the same reference signs, and the description thereof will be omitted as appropriate.

In the example of FIG. 8, the combined vector CV represented by an arrow V21 can be obtained by combining the speaker vector C, the speaker vector Tfr, and the speaker vector R.

A position indicated by the combined vector CV is a position indicated by absolute coordinates (x, y, z)=(0.690, 1.155, 0.500), and the combined vector CV can be obtained by the following Expression (3). That is, the combined vector calculation unit 63 calculates the combined vector CV by calculating Expression (3) on the basis of the speaker vector information.

[Math. 3]

CV=R+C+Tfl

=(0.336,0.582,0)+(0,0.219,0)+(0.354,0.354,0.500)

=0.690,1.155,0.5) (3)

The position indicated by the combined vector CV is a position at which the sound image of the sound is localized when the sound of the object as the processing target is reproduced in the speaker system of the speaker layout indicated by the speaker layout information on the basis of the audio data of the Allocentric scheme as the conversion target. More specifically, the sound of the object as the processing target is localized in a certain direction of the position indicated by the combined vector CV as viewed from the listening position (origin O).

Accordingly, it can be said that the calculation of the combined vector CV is to estimate the localization position of the sound of the object at the time of reproduction by the Allocentric scheme, more specifically, the direction in which the sound of the object is localized. In other words, it can be said that the combined vector CV is an estimation result of the localization position of the sound of the object.

The combined vector calculation unit 63 supplies the combined vector obtained by vector combination to the object position determination unit 32 and the meta information conversion unit 24, as the estimated localization information.

Referring back to the description of the flowchart of FIG. 3, in step S17, the object position determination unit 32 converts the estimated localization information supplied from the combined vector calculation unit 63 into the object position data in the polar coordinate format, and supplies the object position data to the object metadata output unit 25.

The object position determination unit 32 calculates the object position data of the Egocentric scheme from the estimated localization information by converting the position (direction) indicated by the estimated localization information, that is, the combined vector, into the position (direction) in the polar coordinate format with the listening position as a reference.

For example, in a case where the absolute coordinates (x, y, z)=(0.690, 1.155, 0.500) represented in Expression (3) are obtained as the estimated localization information (combined vector), the object position data of the Egocentric scheme can be obtained by calculating the following Expression (4).

$$\begin{matrix}[ Math . 4 ] & \\ \begin{matrix}Az = atan 2 ( - x , y ) * \frac{180}{π} \\ = atan 2 ( - 0.69 , 1.155 ) * \frac{180}{π} \\ = - 30.86\end{matrix} & ( 4 )\end{matrix}$$

$$\begin{matrix}El = atan 2 ( z , \sqrt{{x}^{2} + {y}^{2}} ) * \frac{180}{π} \\ = atan 2 ( 0.5 , \sqrt{{0.69}^{2} + {1.155}^{2}} ) * \frac{180}{π} \\ = 20.39\end{matrix}$$

$$Rad = \sqrt{{x}^{2} + {y}^{2} + {z}^{2}} = 1.43$$

In Expression (4), absolute coordinates (x, y, z)=(0.690, 1.155, 0.500) are converted into polar coordinates (Az, El, Rad)=(−30.86, 20.39, 1.43) based on the listening position, that is, with the origin O of the absolute coordinate space (xyz space) as a reference by coordinate conversion based on the physical law. Then, the polar coordinates are used as the object position data of the Egocentric scheme.

In a case where the absolute coordinates (x, y, z) as the object positional information is (0.8, 1, 0.5), when the absolute coordinates (x, yz)=(0.8, 1, 0.5) are converted into the polar coordinates on the basis of a simple physical law, the polar coordinates (Az, El, Rad)=(−38.66, 21.33, 1.37) are obtained, and a shift occurs in the localization position.

By contrast, the metadata conversion device 11 estimates the localization position, and calculates the object position data in the polar coordinate format on the basis of the estimation result.

Therefore, polar coordinates (Az, El, Rad)=(−30.86, 20.39, 1.43) different from the above-described polar coordinates (Az, El, Rad)=(−38.66, 21.33, 1.37) are obtained as the localization position, and it can be seen that the localization of the sound is maintained. That is, it can be seen that the object position data of the Allocentric scheme can be converted into the object position data of the Egocentric scheme while maintaining the localization of the sound.

In step S18, the meta information conversion unit 24 converts the meta information supplied from the object metadata input unit 22 on the basis of the estimated localization information supplied from the combined vector calculation unit 63. The estimated localization information is converted into the object position data of the Egocentric scheme by simple coordinate conversion in the object position determination unit 32. Therefore, it can also be said that the performing of the conversion of the meta information on the basis of the estimated localization information is to perform the conversion of the meta information on the basis of the object position data of the Egocentric scheme. Note that, the object position data of the Egocentric scheme may be supplied from the object position determination unit 32 to the meta information conversion unit 24 and may be used for conversion of the meta information. Furthermore, the processing of step S18 is not necessarily executed.

For example, the meta information conversion unit 24 calculates the following Expression (5) on the basis of a radius “Rad” constituting polar coordinates as the object position data of the Egocentric scheme obtained from the estimated localization information. Therefore, gain information Gain as the meta information of the Allocentric scheme supplied from the object metadata input unit 22 is converted into gain information Gain’ of the Egocentric scheme.

$$\begin{matrix}[ Math . 6 ] & \\ {Gain}^{′} = Gain \times \frac{1}{Rad } & ( 5 )\end{matrix}$$

At the time of estimating the localization position by the Allocentric scheme in step S14 to step S16, the combined vector obtained by combining the speaker vectors is used as the estimated localization information indicating the localization position of the sound of the object as the processing target.

Therefore, as the panning gain value of the object is larger, a distance from the listening position (origin O) to the localization position indicated by the estimated localization information becomes longer. That is, a radius Rad of the object position data of the Egocentric scheme increases. In a real space, a distance from the listening position to the localization position is longer, and the farther the object is positioned, the smaller the sound of the object is to be heard.

Therefore, the meta information conversion unit 24 corrects (modifies) the gain information in accordance with the radius Rad, that is, the distance from the listening position to the localization position of the sound of the object such that the sound of the object can be heard at a more appropriate volume, and sets the corrected gain information as the gain information of the Egocentric scheme.

The meta information conversion unit 24 sets the meta information obtained by appropriately converting the meta information of the Allocentric scheme as the meta information stored in the object metadata of the Egocentric scheme, that is, the metadata of the Egocentric scheme, and supplies the metadata to the object metadata output unit 25.

In step S19, the object metadata output unit 25 generates the object metadata of the Egocentric scheme, and outputs the object metadata to a subsequent stage.

For example, the object metadata output unit 25 outputs data including the object position data in the polar coordinate format supplied from the object position determination unit 32 and the metadata supplied from the meta information conversion unit 24, as the object metadata of the Egocentric scheme.

By the above processing, for the object as the processing target, the object metadata of the Allocentric scheme in the period as the processing target is converted into the object metadata of the Egocentric scheme.

In step S20, the metadata conversion device 11 determines whether or not the processing is performed on all pieces of time-series object metadata of the object as the processing target.

For example, in step S20, for the object as the processing target, in a case where all of a plurality of periods such as all frames of a content are set as the period as the processing target and pieces of the object metadata of the Allocentric scheme in these periods are converted into pieces of the object metadata of the Egocentric scheme, it is determined that the processing is performed for all the pieces of object metadata.

In a case where it is determined in step S20 that the processing is not performed on all the pieces of object metadata, thereafter, the processing returns to step S12, and the above-described processing is repeatedly performed. That is, the conversion of the object metadata is performed with a new period as the processing target.

By contrast, in a case where it is determined in step S20 that the processing is performed on all the pieces of object metadata, the processing in step S21 is then performed.

In step S21, the metadata conversion device 11 determines whether or not the processing is performed on all the objects.

For example, in step S21, in a case where all the objects are set as the processing target and the pieces of object metadata of the Allocentric scheme in all the periods of all the objects are converted into pieces of object metadata of the Egocentric scheme, it is determined that the processing is performed on all the objects.

In a case where it is determined in step S21 that the processing is not performed on all the objects, thereafter, the processing returns to step S12, and the above-described processing is repeatedly performed. That is, a new object is set as the processing target, and the object metadata is converted.

By contrast, in a case where it is determined in step S21 that the processing is performed on all the objects, the metadata conversion processing ends.

As described above, the metadata conversion device 11 estimates the localization position of the sound at the time of reproduction by the Allocentric scheme on the basis of the speaker layout information of the Allocentric scheme. Then, the metadata conversion device 11 generates the object metadata of the Egocentric scheme on the basis of the estimation result of the localization position.

By doing so, it is possible to convert the object metadata of the Allocentric scheme into the object metadata of the Egocentric scheme while maintaining the localization of the sound. Therefore, audio data can be shared (data sharing) between spatial audio schemes different from each other, that is, between data formats different from each other while maintaining the localization of the sound.

Note that, in the above description, a case where the waveform data of the object is stored in the audio data, as waveform data of each of a plurality of sound sources, and the object metadata of the object is converted has been described. That is, an example in which the sound source is the object has been described. However, the audio data may include waveform data of each channel (channel-based waveform data) as the waveform data of the sound source.

In such a case, since the sound based on the waveform data of the channel is output (reproduced) from the speaker corresponding to the channel, the speaker corresponding to the channel is the sound source. That is, the speaker corresponding to the channel can be regarded as the object.

Accordingly, when the speaker positional information indicating the position of the speaker corresponding to the channel is used as the object positional information indicating the position of the object, it is possible to obtain the object metadata of the Egocentric scheme for the waveform data of the channel.

In other words, the waveform data of the channel can be used as the waveform data of one object (sound source), and the object position data of the waveform data of the channel can be generated.

For example, in a case where the waveform data of the channel is included in the audio data of the Allocentric scheme, the speaker layout information input unit 21 supplies the speaker positional information of the speaker corresponding to the channel extracted from the speaker layout information to the panning gain calculation unit 61.

The panning gain calculation unit 61 sets the speaker positional information supplied from the speaker layout information input unit 21, as the object positional information, and calculates the panning gain value for the speaker corresponding to the channel on the basis of the object positional information and the speaker configuration information.

Furthermore, in the speaker vector generation unit 62, the combined vector calculation unit 63, and the object position determination unit 32 in a subsequent stage of the panning gain calculation unit 61, the object position data is generated similarly to the case of the object position data of the object.

Therefore, the object position data generation unit 23 sets the speaker positional information of the speaker corresponding to the channel as the object position data of the Allocentric scheme, and converts the object position data into the object position data of the Egocentric scheme.

Furthermore, in the metadata conversion processing described with reference to FIG. 3, all pieces of time-series object metadata are prepared, and the object metadata can be converted offline.

By contrast, for example, there is a case where the object metadata of each period such as a frame is sequentially supplied in time series, and it is necessary to sequentially convert the object metadata in real time.

In such a case, processing of converting pieces of object metadata of all the objects in one period such as a frame is repeatedly performed every period. That is, in the metadata conversion processing illustrated in FIG. 3, the processing in step S21 is performed after the processing in step S19, and the processing in step S20 is performed after the processing in step S21.

### <Modification 1 of First Embodiment>

### <Description of Metadata Conversion Processing>

Incidentally, in the above description, an example in which the object position data is converted by estimating the localization position of the sound (sound image) of the object for all the objects has been described.

However, the present invention is not limited thereto, and the object position data may be converted by coordinate conversion based on a simple physical law without estimating the localization position for a part of objects.

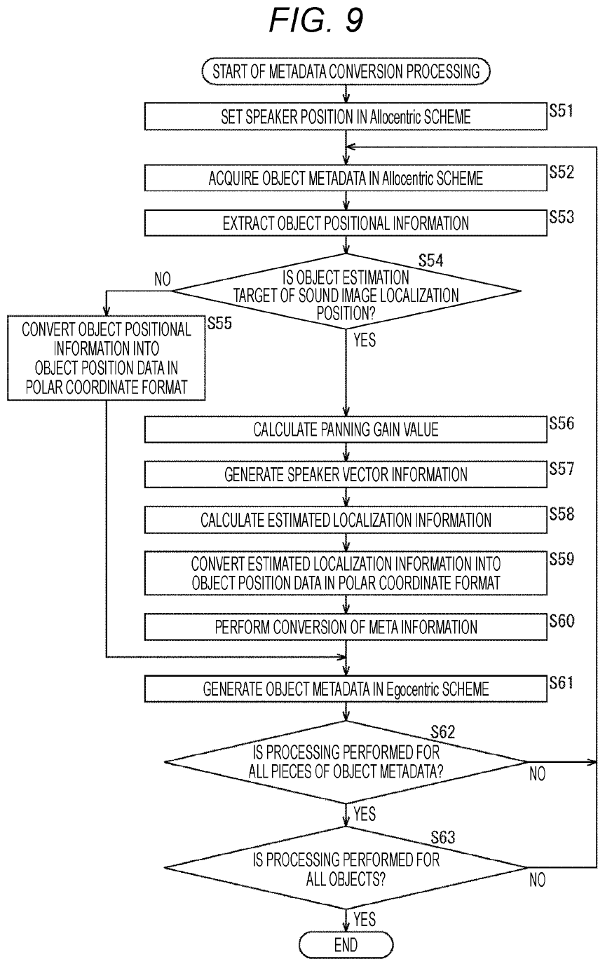

In such a case, for example, the metadata conversion device 11 performs the metadata conversion processing illustrated in FIG. 9. The metadata conversion processing by the metadata conversion device 11 will be described below with reference to the flowchart of FIG. 9.

Note that, since the processing in step S51 to step S53 is similar to the processing in step S11 to step S13 in FIG. 3, the description thereof will be omitted.

In step S54, the object position data generation unit 23 determines whether or not the object as the processing target is an estimation target of the sound image localization position (whether or not the object is the estimation target).

For example, the object position data generation unit 23 performs determination on the basis of a selection operation by the user, meta information extracted from the object metadata of the Allocentric scheme, flag information separately supplied together with the object metadata, and the like.

As an example, for example, in a case where a signal corresponding to the selection operation of the user is supplied to the object position data generation unit 23, the object position data generation unit 23 specifies whether or not the object as the processing target is selected by the user, as the estimation target of the sound image localization position on the basis of the supplied signal. Note that, instead of the selection operation of the user, flag information indicating whether or not the object is the estimation target of the sound image localization position, which is set in advance by the content creator, the user (listener), or the like and given to the waveform data of the object or the object metadata, may be used.

Moreover, for example, in a case where the name information of the object as the processing target is included in the meta information, when the name of the object indicated by the name information is a name indicating an object of a predetermined specific type such as an object of a reverb component, it may be determined that the object is not the estimation target of the sound image localization position. Here, the object of the reverb component is, for example, an object such as initial reflection sound or rear reverberation sound.

For example, for an object in which localization sensation of the sound image is not important, such as the object of the reverb component, it is possible to reduce a processing time or reduce a processing load by only performing coordinate conversion based on a simple physical law to generate the estimated localization information.

Similarly, for example, an object having a low priority indicated by the priority information, that is, an object of which a priority is equal to or less than a predetermined threshold value can also be regarded as an object in which the localization sensation of the sound image is not important. Therefore, when the priority information is included as the meta information, whether or not the object is the estimation target of the sound image localization position may be determined on the basis of the priority information. Here, the priority of each object may be constant throughout the entire content or may be dynamically changed every period as the processing target. In a case where the priority is constant throughout the entire content, it is possible to reduce the processing time and reduce the processing load by only performing the coordinate conversion based on a simple physical law to generate the estimated localization information for an object of which a priority is equal to or less than a predetermined threshold value, that is, an object of which the localization sensation of the sound image is not important. Furthermore, in a case where the priority is dynamically changed every period as the processing target, since the sound image localization position is estimated for an object having a high priority every period as the processing target, it is possible to exert an effect particularly in content such as free viewpoint audio in which a distance or the like between the user and the object changes as the user freely moves in the space. In other words, in the content such as the free viewpoint audio, it is possible to realize the content more reflecting the intention of the creator (producer) and the user experience. Moreover, object metadata other than the priority may be dynamically changed every period as the processing target.

In a case where it is determined in step S54 that the object is not the estimation target of the sound image localization position, in step S55, the object position data generation unit 23 converts the object positional information into the object position data in the polar coordinate format by coordinate conversion based on a simple physical law.

Specifically, the object position data generation unit 23 calculates (generates) the object position data in the polar coordinate format by calculating the following Expression (6) on the basis of the object positional information supplied from the object metadata input unit 22, that is, the object position data of the Allocentric scheme.

$$\begin{matrix}[ Math . 6 ] & \\ Az = atan 2 ( - x , y ) * \frac{180}{π} & ( 6 )\end{matrix}$$

$$El = atan 2 ( z , \sqrt{{x}^{2} + {y}^{2}} ) * \frac{180}{π}$$

$$Rad = \sqrt{{x}^{2} + {y}^{2} + {z}^{2}}$$

By Expression (6), the absolute coordinates (x, y, z), which are the object positional information of the Allocentric scheme, that is, in the absolute coordinate format, are converted into the Egocentric scheme, that is, the polar coordinates (Az, El, Rad), which are the object position data in the polar coordinate format with the origin O of the absolute coordinate space (xyz space) as a reference.

The object position data generation unit 23 supplies the object position data in the polar coordinate format obtained by the calculation of Expression (6) to the object metadata output unit 25, and then the processing proceeds to step S61.

By contrast, in a case where it is determined in step S54 that the object as the processing target is the estimation target of the sound image localization position, the processing of step S56 to step S60 is then performed, and the processing proceeds to step S61.

Note that, since the processing in step S56 to step S60 is similar to the processing in step S14 to step S18 in FIG. 3, the description thereof will be omitted. Furthermore, for the object that is not the estimation target of the sound image localization position, the meta information may be converted on the basis of the object position data calculated in step S55, for example, similarly to the processing in step S18 in FIG. 3.

After the processing in step S55 or step S60 is performed, the processing in step S61 to step S63 is performed, and the metadata conversion processing ends. Since the processing of step S61 to step S63 is similar to the processing of step S19 to step S21 of FIG. 3, the description thereof will be omitted.

As described above, the metadata conversion device 11 determines whether or not the object is the estimation target of the sound image localization position, and generates the object position data in the polar coordinate format by a method corresponding to the determination result. By doing so, the processing time and the processing load can be reduced.

### <Application Example>

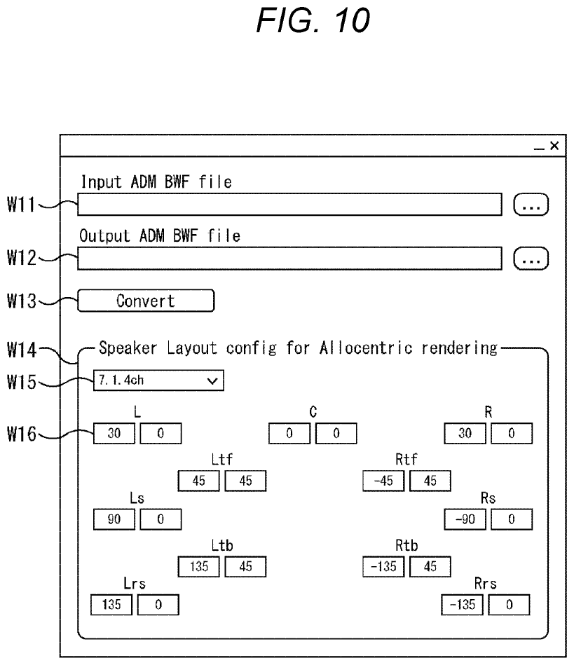

FIG. 10 illustrates a display screen example of an application having a function of the conversion of the object metadata, that is, the conversion of the audio data described above.

For example, an information processing apparatus such as a computer that realizes the metadata conversion device 11 executes a program for realizing an application to display a display screen illustrated in FIG. 10.

In this example, an input designation field W11 which is an interface for designating a file name of an input file and an output designation field W12 which is an interface for designating a file name of an output file are provided on the display screen.

For example, the user designates the input file, that is, the audio data as the conversion target by operating the input designation field W11.

Note that, as an example, here, the input file has an audio definition model (ADM) broadcast wave format (BWF) file format, but may have a format in which a file including pulse code modulation (PCM) data and object metadata or a file group such as a folder is designated.

The ADM BWF file mentioned here is a BWF file including a chunk storing metadata according to an ADM standard and PCM data.

For example, the ADM standard is described in detail in “Recommendation ITU-R BS. 2076-2 (10/2019) “Audio definition model”” and the like. Furthermore, for example, BWF is described in detail in “EBU Tech 3285—Specification of the Broadcast Wave Format (BWF) version 2.0” and the like.

Furthermore, the user designates an output file, that is, a file name of the audio data obtained by the conversion by operating the output designation field W12.

As an example, here, the output file is in the ADM BWF file format, but a file including PCM data and object metadata or a file group such as a folder may be designated, similarly to the case of the input file.

An execution button W13 operated when the input audio data (input file) is converted into an output file, and a setting area W14 for setting the speaker layout used for rendering reproduction of the Allocentric scheme are also provided on the display screen.

A pull-down menu W15 for selecting the number of channels and the channel configuration of the speaker layout is provided in the setting area W14, and the user designates the above-described speaker configuration information by operating the pull-down menu W15.

For example, the user operates the pull-down menu W15 to switch the channel configuration of the speaker system such as 5.1.2ch, 7.1.4ch, or 9.1.6ch.

Furthermore, a text box, such as a text box W16, for setting the arrangement position of each speaker of the designated speaker layout, more specifically, a direction in which each speaker is installed as viewed from a listening position is provided in the setting area W14.

Specifically, for example, a horizontal angle (Azimuth) of the speaker is input to a left field (text box) of the text box W16, and a vertical angle (Elevation) of the speaker is input to a right field (text box) of the text box W16.

In this case, the speaker layout information input unit 21 appropriately converts the position of the speaker represented by the input horizontal angle and vertical angle into the speaker positional information in the absolute coordinate format.

Note that, here, although an example in which the arrangement position of the speaker is input at an angle (horizontal angle and vertical angle) viewed from the listening position is illustrated, the arrangement position of the speaker may be input at coordinates (absolute coordinates) in the absolute coordinate format.

When the operation is performed on the input designation field W11 and the output designation field W12 to designate the input file and the output file, the operation is performed on the setting area W14 to set the speaker layout, and then the execution button W13 is operated (pressed), the conversion of the audio data is executed.

That is, the audio data of the Allocentric scheme designated as the input file is converted into the audio data of the Egocentric scheme which is the output file.

At this time, the metadata conversion device 11 performs the metadata conversion processing described with reference to FIGS. 3 and 9, and generates the object metadata of the Egocentric scheme.

Then, a file including the object metadata of each object of the Egocentric scheme and the PCM data as the waveform data of each object of the Egocentric scheme is generated as the output file.

Here, an independent application has been described as an example, but this conversion function may be implemented in an audio editing application called a digital audio workstation (DAW). That is, for example, the data edited on the DAW by the Allocentric scheme may be converted into the data of the Egocentric scheme by converting the object positional information and the gain information by giving the speaker layout information and the like by the present technology. Furthermore, this conversion function may be implemented on the DAW and the like by installing a plug-in equipped with the present technology.

### <Configuration Example of Reproduction Device>

Furthermore, the metadata conversion device 11 to which the present technology is applied is incorporated into a reproduction device, a content can be reproduced by a device of the Egocentric scheme with audio data of the Allocentric scheme as an input.

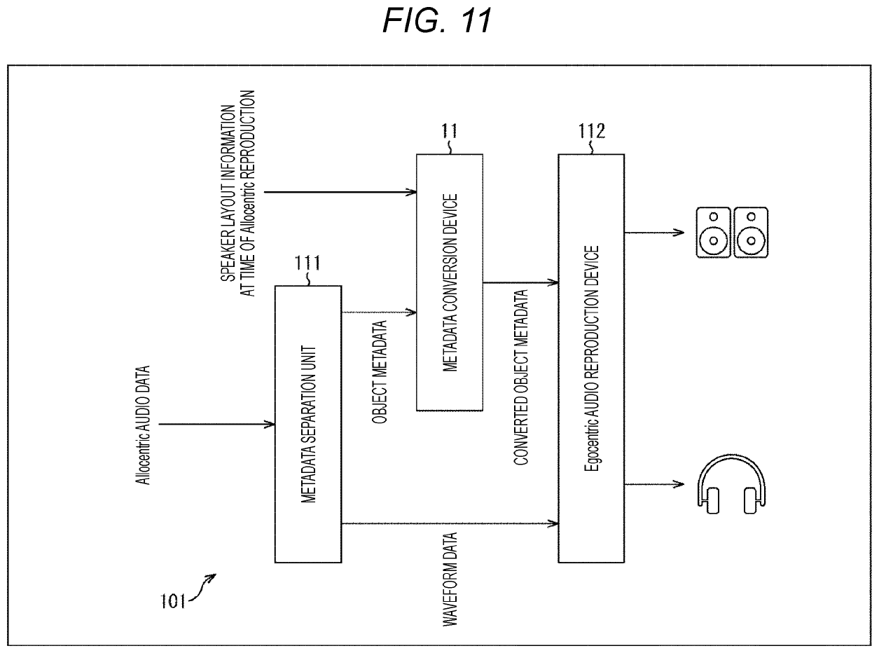

Such a reproduction device has a configuration illustrated in FIG. 11, for example. Note that, in FIG. 11, portions corresponding to those in FIG. 1 are denoted by the same reference signs, and the description thereof will be omitted as appropriate.

A reproduction device 101 illustrated in FIG. 11 includes a metadata separation unit 111, a metadata conversion device 11, and an Egocentric audio reproduction device 112.

The audio data of the Allocentric scheme to be reproduced from now is input (supplied) to the metadata separation unit 111, and the metadata separation unit 111 separates the supplied audio data into the object metadata and the waveform data. That is, the object metadata and the waveform data of each object are extracted from the audio data.

For example, the audio data is input to the reproduction device 101 in a state of being extracted from a bit stream and decoded, that is, in a state of being uncompressed.

The metadata separation unit 111 supplies the extracted object metadata of each object to the metadata conversion device 11, and supplies the extracted waveform data of each object to the Egocentric audio reproduction device 112.

In addition to the object metadata from the metadata separation unit 111, speaker layout information when reproduction by the Allocentric scheme is performed is supplied to the metadata conversion device 11 similarly to the case of FIG. 1.

The speaker layout information may be stored in the bit stream together with the audio data of the Allocentric scheme.

The metadata conversion device 11 performs metadata conversion processing similar to the case of FIG. 3 or FIG. 9 on the basis of the supplied speaker layout information and object metadata, and supplies the resultant object metadata of the Egocentric scheme to the Egocentric audio reproduction device 112.

The audio data of the Allocentric scheme may include channel-based waveform data, that is, waveform data of the channel.

In such a case, as described above, the speaker positional information of the speaker corresponding to the channel may be set as the object position data of the Allocentric scheme, and the object position data may be converted into the object position data of the Egocentric scheme. That is, the waveform data of the channel may be regarded as the waveform data of the object, and the object position data may be generated.

Note that, the object position data of the waveform data of the channel may not be generated, and the waveform data of the channel may be supplied to the Egocentric audio reproduction device 112 with no change, as the (channel-based) waveform data every channel.

Furthermore, hereinafter, the object metadata of the Egocentric scheme generated by the metadata conversion device 11 is also particularly referred to as converted object metadata.

The Egocentric audio reproduction device 112 performs rendering processing of the Egocentric scheme on the basis of the converted object metadata of each object supplied from the metadata conversion device 11 and the waveform data of each object supplied from the metadata separation unit 111. That is, the Egocentric audio reproduction device 112 functions as a rendering processing unit. Here, the rendering processing of the Egocentric scheme may be, for example, rendering processing using VBAP, or may be processing other than VBAP.

By the rendering processing, output data every channel for reproducing the sound of each object is generated from the waveform data of each object.

For example, when an output destination of the output data is a headphone, two-channel output data is generated, and when the output destination of the output data is a speaker system of 7.1.4ch, output data of 7.1.4ch is generated. Furthermore, binaural two-channel output data for virtually reproducing the speaker system of, for example, 7.1.4ch by a convolution arithmetic operation of a binaural room impulse response (BRIR), a head related transfer function (HRTF), or the like may be output to the headphone. Note that, here, although the headphone has been described as an example, the present invention is not limited thereto, and similar processing may be performed on earphones, hearing aids, head mounted displays (HMIDs), and other devices.

The Egocentric audio reproduction device 112 supplies the output data generated by the rendering processing to the headphone or the speaker system as the output destination, and reproduces the sound of the content, that is, the sound of each object.

### Second Embodiment

### <Configuration Example of Metadata Conversion Device>

In the above description, a case where the object metadata (audio data) of the Allocentric scheme is converted into the object metadata (audio data) of the Egocentric scheme has been described as an example.

However, the present invention is not limited thereto, and the object metadata (audio data) of the Egocentric scheme may be converted into the object metadata (audio data) of the Allocentric scheme.

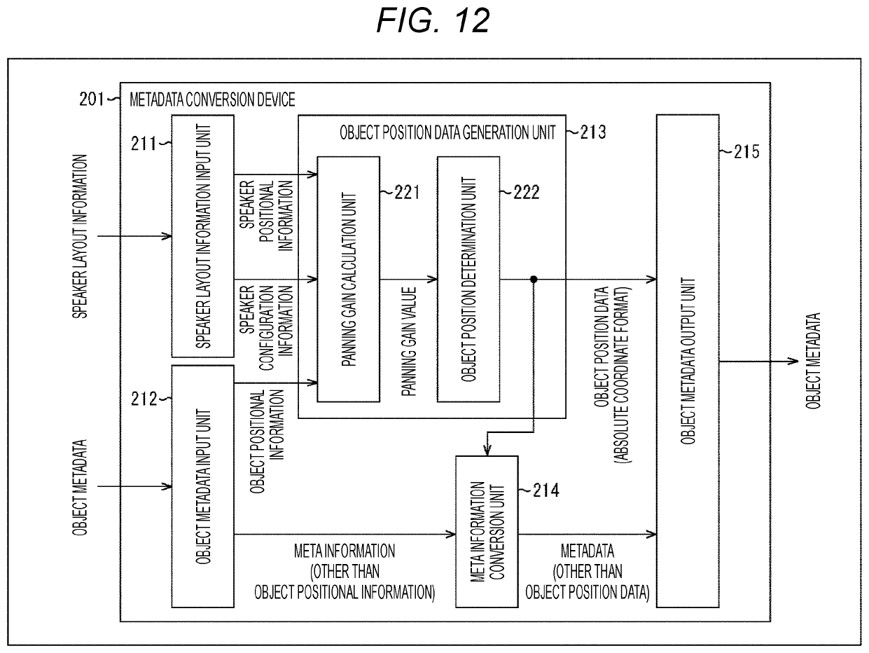

In such a case, the metadata conversion device has the configuration illustrated in FIG. 12, for example.

A metadata conversion device 201 illustrated in FIG. 12 includes a speaker layout information input unit 211, an object metadata input unit 212, an object position data generation unit 213, a meta information conversion unit 214, and an object metadata output unit 215.

The speaker layout information input unit 211 acquires speaker layout information input from an outside, extracts speaker positional information and speaker configuration information from the speaker layout information, and supplies the speaker positional information and the speaker configuration information to the object position data generation unit 213. This speaker configuration information is required for the rendering processing by the Allocentric scheme.

Here, the speaker layout information acquired by the speaker layout information input unit 211 is information regarding the speaker system when the content is actually reproduced on the basis of the audio data of the Allocentric scheme after conversion. That is, the speaker layout information indicating the channel configuration of the speaker system actually used for reproduction by the Allocentric scheme, the arrangement position of the speaker, and the like is acquired.

For example, in a case where the speaker layout of the speaker system used for actual reproduction by the Allocentric scheme is 7.1.4ch, the speaker layout information illustrated in FIG. 4 is acquired.

The object metadata input unit 212 acquires the object metadata of the Egocentric scheme from the outside, and extracts the object positional information and the meta information from the acquired object metadata.

For example, the object position data in the polar coordinate format included in the object metadata of the Egocentric scheme is extracted as the object positional information with no change. Furthermore, for example, the name information, the type information, the size information, the priority information, the spread information, the gain information, and the like included in the object metadata of the Egocentric scheme are extracted as the meta information.

The object metadata input unit 212 supplies the extracted object positional information to the object position data generation unit 213, and supplies the extracted meta information to the meta information conversion unit 214.

The object position data generation unit 213 generates the object position data indicating the position of the object at the time of reproduction by the Allocentric scheme on the basis of the speaker positional information, the speaker configuration information, and the object positional information. In other words, the object position data generation unit 213 converts the object position data of the Egocentric scheme into the object position data of the Allocentric scheme.

The object position data generation unit 213 includes a panning gain calculation unit 221 and an object position determination unit 222.

The panning gain calculation unit 221 calculates the panning gain value on the basis of the speaker positional information and the speaker configuration information supplied from the speaker layout information input unit 211 and the object positional information supplied from the object metadata input unit 212, and supplies the panning gain value to the object position determination unit 222.

For example, the panning gain calculation unit 221 calculates the panning gain value allocated to each speaker indicated by the speaker configuration information every object on the basis of the rendering method of the Egocentric scheme such as the VBAP. Then, the panning gain value is supplied to the object position determination unit 222 with no change, as the panning gain value every object allocated to each speaker at the time of reproduction by the Allocentric scheme. Note that, the panning gain calculation unit 221 may use the rendering method other than the VBAP.

The object position determination unit 222 determines the position of each object on the basis of the panning gain value of each speaker every object supplied from the panning gain calculation unit 221, and uses the determination result as the object position data.

For example, the object position determination unit 222 calculates the object position data in the absolute coordinate format from the panning gain value of each speaker of the object by performing back calculation of the rendering method of the Allocentric scheme, that is, calculation of obtaining the panning gain value from the object position data in the absolute coordinate format.

The object position determination unit 222 supplies the calculated object position data in the absolute coordinate format to the meta information conversion unit 214 and the object metadata output unit 215, as the object position data of the Allocentric scheme.

In the Egocentric scheme, the position of the object indicated by the object position data becomes the localization position of the sound of the object with no change.

Therefore, in the object position data generation unit 213 that converts the object position data of the Egocentric scheme into the object position data of the Allocentric scheme, the sound image localization estimation unit 31 that estimates the localization position of the sound of the object is not provided. That is, the object position data generation unit 213 calculates the panning gain value and determines the object position.

The meta information conversion unit 214 appropriately converts the meta information supplied from the object metadata input unit 212 on the basis of the object position data supplied from the object position determination unit 222, and supplies the metadata obtained by the conversion to the object metadata output unit 215.

The meta information conversion unit 214 converts the meta information of the Egocentric scheme into the meta information of the Allocentric scheme, and outputs the meta information after conversion as the metadata. Note that, the meta information is not necessarily converted.

The object metadata output unit 215 outputs data including the object position data in the absolute coordinate format supplied from the object position determination unit 222 and the metadata supplied from the meta information conversion unit 214, as the object metadata of the Allocentric scheme.

### <Description of Metadata Conversion Processing>

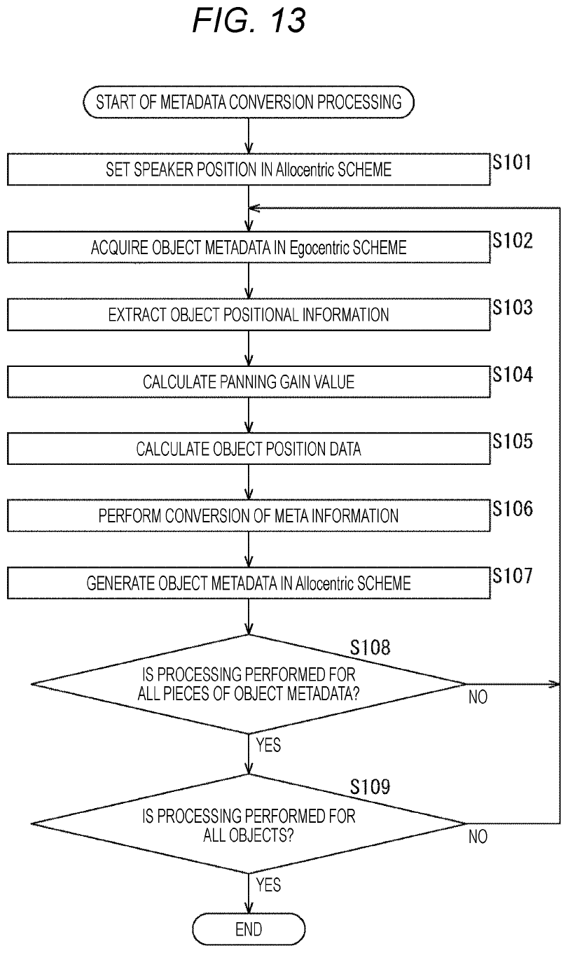

The metadata conversion processing by the metadata conversion device 201 will be described with reference to the flowchart in FIG. 13. This metadata conversion processing is started, for example, when the user designates the audio data of the Egocentric scheme as the conversion target.

In step S101, the speaker layout information input unit 211 sets the speaker position of the Allocentric scheme in accordance with the operation of the user and the like.

For example, in step S101, similarly to the case of step S11 in FIG. 3, the information regarding the speaker system when the audio reproduction is actually performed by the Allocentric scheme is set in accordance with the designation operation of the user, and the speaker layout information indicating the setting result is obtained.

The speaker layout information input unit 211 extracts the speaker positional information and the speaker configuration information from the speaker layout information, and supplies the speaker positional information and the speaker configuration information to the panning gain calculation unit 221.

In step S102, the object metadata input unit 212 acquires the object metadata of the Egocentric scheme from the audio data designated by the user.

For example, in step S102, similarly to the case in step S12 in FIG. 3, the object metadata in the period as the processing target of the object as the processing target is acquired.

In step S103, the object metadata input unit 212 extracts the object positional information from the acquired object metadata of the Egocentric scheme, and supplies the object positional information to the panning gain calculation unit 221. Here, the object positional information in the polar coordinate format is extracted. Furthermore, the object metadata input unit 212 also extracts the meta information from the object metadata of the Egocentric scheme, and supplies the meta information to the meta information conversion unit 214.

In step S104, the panning gain calculation unit 221 calculates the panning gain value on the basis of the speaker positional information and the speaker configuration information supplied from the speaker layout information input unit 211 and the object positional information supplied from the object metadata input unit 212, and supplies the panning gain value to the object position determination unit 222.

For example, in step S104, the panning gain value when the sound of the object as the processing target is reproduced by the Egocentric scheme by the rendering method of the Egocentric scheme such as the VBAP is calculated every speaker arranged at the position indicated by the speaker positional information. Then, the panning gain value of each speaker is used with no change as the panning gain value of each speaker by the Allocentric scheme.

In step S105, the object position determination unit 222 calculates the object position data in the absolute coordinate format of the object as the processing target on the basis of the panning gain value of each speaker supplied from the panning gain calculation unit 221.

Specifically, for example, the object position data is calculated from the panning gain value of each speaker by performing calculation when the panning gain value is obtained from the object position data in the absolute coordinate format by the rendering method of the Allocentric scheme in a reverse order (back calculation).

In the Egocentric scheme, the sound of the object is localized at the same position regardless of the arrangement position of the speaker. Therefore, when the back calculation is performed on the object position data of the Allocentric scheme with the panning gain value allocated to the speaker by the Egocentric scheme, the object position data of the Egocentric scheme can be converted into the object position data of the Allocentric scheme while maintaining the localization of the sound.

The object position determination unit 222 supplies the calculated object position data in the absolute coordinate format to the meta information conversion unit 214 and the object metadata output unit 215.

In step S106, the meta information conversion unit 214 converts the meta information supplied from the object metadata input unit 212 on the basis of the object position data supplied from the object position determination unit 222. Note that, the processing in step S106 is not necessarily executed.

For example, similarly to the case in step S18 in FIG. 3, the meta information conversion unit 214 converts the gain information corresponding to the distance from the listening position to the object and the like, that is, corrects (modifies) the gain information on the basis of the object position data.

The meta information conversion unit 214 supplies the meta information of the Allocentric scheme obtained by appropriately converting the meta information of the Egocentric scheme to the object metadata output unit 215, as the metadata of the Allocentric scheme stored in the object metadata.

In step S107, the object metadata output unit 215 generates the object metadata of the Allocentric scheme, and outputs the object metadata to a subsequent stage.

For example, the object metadata output unit 215 outputs data including the object position data in the absolute coordinate format supplied from the object position determination unit 222 and the metadata supplied from the meta information conversion unit 214, as the object metadata of the Allocentric scheme.

By the above processing, for the object as the processing target, the object metadata of the Egocentric scheme in the period as the processing target is converted into the object metadata of the Allocentric scheme.

After the processing in step S107 is performed, the processing in step S108 and step S109 is performed, and the metadata conversion processing ends. However, since the processing is similar to the processing in step S20 and step S21 in FIG. 3, the description thereof is omitted.

As described above, the metadata conversion device 201 calculates the panning gain value at the time of reproduction by the Egocentric scheme on the basis of the speaker layout information by the Allocentric scheme, and calculates the object position data by the Allocentric scheme.

By doing so, it is possible to convert the object metadata of the Egocentric scheme into the object metadata of the Allocentric scheme while maintaining the localization of the sound. Therefore, the audio data can be shared (data sharing) between spatial audio schemes different from each other, that is, between data formats different from each other while maintaining the localization of the sound.

As described above, according to the present technology, it is possible to convert the object metadata while maintaining the localization sensation of the sound between different data formats (spatial audio schemes) in object-based audio, specifically, between the Allocentric scheme and the Egocentric scheme. Therefore, it is possible to realize data sharing holding the localization (localization sensation) of the sound between data formats different from each other.

For example, in the first embodiment described above, the localization direction of the sound of the object by the rendering method (Allocentric scheme) in the data format before conversion, that is, the localization position is estimated. Then, when the audio reproduction is performed by the rendering method (Egocentric scheme) in the data format after conversion, the object position data in which the sound is localized in the localization direction is determined, and the object position data is used as the object position data in the data format after conversion. Therefore, it is possible to convert the audio data while maintaining the localization of the sound.

In particular, in the first embodiment, the combined vector indicating the localization position of the sound of the object is generated by combining the speaker vector including the position (direction) of each speaker at the time of reproduction by the Allocentric scheme and the gain value (panning gain value) allocated to the speaker. By this method, the localization direction of the sound of the object by the rendering processing of the Allocentric scheme, that is, the localization position can be estimated.

Furthermore, in Modification 1 of the first embodiment, every object, whether or not to convert the object position data based on the estimation of the sound image localization position or to convert the object position data by coordinate conversion based on a simple physical law is determined. By doing so, the processing time and the processing load (processing amount) at the time of conversion can be reduced.

Moreover, for example, in the second embodiment, the panning gain value of each speaker at the time of reproduction by the rendering method (Allocentric scheme) of the data format after conversion is calculated by the rendering method (Egocentric scheme) of the data format before conversion. Then, the object position data in the data format after conversion is calculated by back calculation based on the panning gain value of each speaker. Therefore, it is possible to convert the audio data while maintaining the localization of the sound.

### <Configuration Example of Computer>

Incidentally, the above-described series of processing can be executed by hardware or software. In a case where the series of processing is executed by the software, a program forming the software is installed on the computer. Here, examples of the computer include a computer incorporated in dedicated hardware, and for example, a general-purpose personal computer capable of executing various functions by installing various programs or the like.

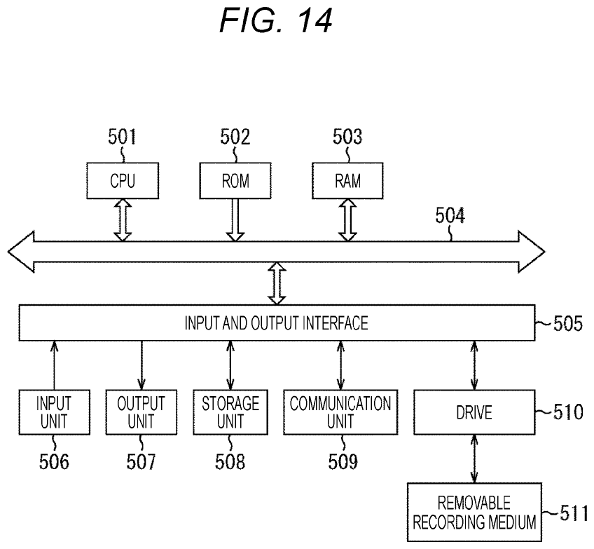

FIG. 14 is a block diagram illustrating a configuration example of the hardware of the computer that executes the series of processing described above according to the program.

In the computer, a central processing unit (CPU) 501, a read only memory (ROM) 502, and a random access memory (RAM) 503 are mutually connected by a bus 504.

Moreover, an input and output interface 505 is connected to the bus 504. An input unit 506, an output unit 507, a recording unit 508, a communication unit 509, and a drive 510 are connected to the input and output interface 505.

The input unit 506 includes a keyboard, a mouse, a microphone, an imaging device, and the like. The output unit 507 includes a display, a speaker, and the like. The recording unit 508 includes a hard disk, a non-volatile memory, and the like. The communication unit 509 includes a network interface and the like. The drive 510 drives a removable recording medium 511 such as a magnetic disk, an optical disk, a magneto-optical disk, or a semiconductor memory.

In the computer configured as described above, the CPU 501 loads, for example, a program recorded in the recording unit 508 into the RAM 503 via the input and output interface 505 and the bus 504, and executes the program. As a result, the above-described series of processing is performed.

For example, in the computer, when the user operates the input unit 506, the CPU 501 causes the display as the output unit 507 to display the display screen illustrated in FIG. 10 in accordance with the signal from the input unit 506. Then, the CPU 501 realizes the metadata conversion device 11 by executing the program in accordance with the operation on the display screen illustrated in FIG. 10 by the user, and executes the metadata conversion processing described with reference to FIGS. 3 and 9.

The program executed by the computer (CPU 501) can be provided by being recorded on the removable recording medium 511 as a package medium and the like, for example. Furthermore, the program can be provided via a wired or wireless transmission medium such as a local area network, the Internet, or digital satellite broadcasting.

In the computer, the program can be installed in the recording unit 508 via the input/output interface 505 by mounting the removable recording medium 511 on the drive 510. Furthermore, the program can be received by the communication unit 509 via the wired or wireless transmission medium to be installed on the recording unit 508. In addition, the program can be installed in the ROM 502 or the recording unit 508 in advance.

Note that, the program to be executed by the computer may be a program that executes processing in time series in accordance with an order described in the present description, or may be a program that executes processing in parallel or at a necessary timing such as when a call is made.

Furthermore, the embodiments of the present technology are not limited to the above-described embodiments, and various modifications are possible without departing from the scope of the present technology.

For example, the present technology can have a configuration of cloud computing in which one function is shared and processed in cooperation by a plurality of devices via a network.

Furthermore, each step described in the flowchart described above may be performed by a single device, or may be performed by a plurality of devices in a shared manner.

Moreover, in a case where a plurality of pieces of processing is included in one step, the plurality of pieces of processing included in the one step can be executed by one device or executed by a plurality of devices in a shared manner.

Moreover, the present technology may also have following configurations.

(1)

An information processing apparatus including:
an acquisition unit that acquires speaker layout information at a time of reproduction of audio data in a first data format; and
a position data generation unit that converts first position data of a sound source in the first data format or second position data of the sound source in a second data format in which a rendering scheme at the time of reproduction is different from the first data format into the second position data or the first position data on the basis of the speaker layout information.
   (2)

The information processing apparatus according to (1), in which
the rendering scheme at the time of reproduction of the audio data in the first data format is an Allocentric scheme.
   (3)

The information processing apparatus according to (1) or (2), in which
the rendering scheme at the time of reproduction of the audio data in the second data format is an Egocentric scheme.
   (4)

The information processing apparatus according to (3), in which
the rendering scheme is a rendering scheme using at least one of VBAP, HRTF, or BRIR.
   (5)

The information processing apparatus according to any one of (1) to (4), in which
a coordinate format of the first position data is different from a coordinate format of the second position data.
   (6)

The information processing apparatus according to (5), in which
the first position data is position data in an absolute coordinate format, and the second position data is position data in a polar coordinate format with a listening position as a reference.
   (7)

The information processing apparatus according to any one of (1) to (6), in which
the sound source is an object and includes object metadata.
   (8)

The information processing apparatus according to (7), in which
the object metadata is at least one of name information indicating a name of the object, type information indicating a type of the object, size information indicating a size of the object, priority information indicating a priority of the object, spread information indicating spread of the object, or gain information indicating a gain value of the object.
   (9)

The information processing apparatus according to any one of (1) to (8), in which
the position data generation unit estimates a localization position of sound of the sound source at the time of reproduction of the audio data in the first data format on the basis of the speaker layout information and the first position data, and generates the second position data on the basis of an estimation result of the localization position.
   (10)

The information processing apparatus according to (9), in which
the position data generation unit estimates the localization position by calculating a gain value of one or each of a plurality of speakers for the sound source on the basis of the speaker layout information and the first position data, generating, every speaker, a vector having a magnitude of the gain value of the speaker and facing a direction of a position of the speaker, and combining the vectors generated for the one or each of the plurality of speakers.
   (11)

The information processing apparatus according to (9) or (10), in which
the position data generation unit determines whether or not the sound source is an estimation target of the localization position, and generates the second position data by performing coordinate conversion on the first position data of the sound source in a case where it is determined that the sound source is not the estimation target.
   (12)

The information processing apparatus according to (11), in which
the position data generation unit performs the determination on the basis of object metadata of the audio data in the first data format, selection by a user, or preset flag information.
   (13)

The information processing apparatus according to any one of (1) to (8), in which
the position data generation unit calculates a gain value of one or each of a plurality of speakers for the sound source at the time of reproduction of the audio data in the first data format or the second data format on the basis of the speaker layout information and the first position data or the second position data, and generates the second position data or the first position data on the basis of the gain value of the one or each of the plurality of speakers.
   (14)

The information processing apparatus according to any one of (1) to (13), further including:
a meta information conversion unit that converts another information different from the first position data or the second position data, the another information being included in object metadata of the audio data in the first data format or the second data format, into the another information of the object metadata of the audio data in the second data format or the first data format on the basis of the second position data or the first position data obtained by the conversion by the position data generation unit.
   (15)

The information processing apparatus according to (2), in which
in a case where waveform data of a channel is included in the audio data, the position data generation unit uses information indicating a position of a speaker corresponding to the channel, as the first position data, and converts the first position data into the second position data.
   (16)

The information processing apparatus according to (7), further including:
a rendering processing unit that performs rendering processing on the basis of object metadata of the object and waveform data for reproducing sound of the object, the object metadata including the second position data or the first position data obtained by the conversion by the position data generation unit.
   (17)

An information processing method including:
by an information processing apparatus,
acquiring speaker layout information at a time of reproduction of audio data in a first data format; and
converting first position data of a sound source in the first data format or second position data of the sound source in a second data format in which a rendering scheme at the time of reproduction is different from the first data format into the second position data or the first position data, on the basis of the speaker layout information.
   (18)

A program for causing a computer to execute processing of:
acquiring speaker layout information at a time of reproduction of audio data in a first data format; and
converting first position data of a sound source in the first data format or second position data of the sound source in a second data format in which a rendering scheme at the time of reproduction is different from the first data format into the second position data or the first position data on the basis of the speaker layout information.

### REFERENCE SIGNS LIST

11 Metadata conversion device
21 Speaker layout information input unit
22 Object metadata input unit
23 Object position data generation unit
24 Meta information conversion unit
25 Object metadata output unit
31 Sound image localization estimation unit
32 Object position determination unit
201 Metadata conversion device
211 Speaker layout information input unit
212 Object metadata input unit
213 Object position data generation unit
214 Meta information conversion unit

What is claimed is:

1. An information processing apparatus, comprising:
an acquisition unit that acquires speaker layout information at a time of reproduction of audio data in a first data format; and
a position data generation unit that converts first position data of a sound source in the first data format or second position data of the sound source in a second data format in which a rendering scheme at the time of reproduction is different from the first data format into the second position data or the first position data on a basis of the speaker layout information.

2. The information processing apparatus according to claim 1, wherein
the rendering scheme at the time of reproduction of the audio data in the first data format is an Allocentric scheme.

3. The information processing apparatus according to claim 1, wherein
the rendering scheme at the time of reproduction of the audio data in the second data format is an Egocentric scheme.

4. The information processing apparatus according to claim 3, wherein
the rendering scheme is a rendering scheme using at least one of VBAP, HRTF, or BRIR.

5. The information processing apparatus according to claim 1, wherein
a coordinate format of the first position data is different from a coordinate format of the second position data.

6. The information processing apparatus according to claim 5, wherein
the first position data is position data in an absolute coordinate format, and the second position data is position data in a polar coordinate format with a listening position as a reference.

7. The information processing apparatus according to claim 1, wherein
the sound source is an object and includes object metadata.

8. The information processing apparatus according to claim 7, wherein
the object metadata is at least one of name information indicating a name of the object, type information indicating a type of the object, size information indicating a size of the object, priority information indicating a priority of the object, spread information indicating spread of the object, or gain information indicating a gain value of the object.

9. The information processing apparatus according to claim 1, wherein
the position data generation unit estimates a localization position of sound of the sound source at the time of reproduction of the audio data in the first data format on a basis of the speaker layout information and the first position data, and generates the second position data on a basis of an estimation result of the localization position.

10. The information processing apparatus according to claim 9, wherein
the position data generation unit estimates the localization position by calculating a gain value of one or each of a plurality of speakers for the sound source on a basis of the speaker layout information and the first position data, generating, every speaker, a vector having a magnitude of the gain value of the speaker and facing a direction of a position of the speaker, and combining the vectors generated for the one or each of the plurality of speakers.

11. The information processing apparatus according to claim 9, wherein
the position data generation unit determines whether or not the sound source is an estimation target of the localization position, and generates the second position data by performing coordinate conversion on the first position data of the sound source in a case where it is determined that the sound source is not the estimation target.

12. The information processing apparatus according to claim 11, wherein
the position data generation unit performs the determination on a basis of object metadata of the audio data in the first data format, selection by a user, or preset flag information.

13. The information processing apparatus according to claim 1, wherein
the position data generation unit calculates a gain value of one or each of a plurality of speakers for the sound source at the time of reproduction of the audio data in the first data format or the second data format on a basis of the speaker layout information and the first position data or the second position data, and generates the second position data or the first position data on a basis of the gain value of the one or each of the plurality of speakers.

14. The information processing apparatus according to claim 1, further comprising:
a meta information conversion unit that converts another information different from the first position data or the second position data, the another information being included in object metadata of the audio data in the first data format or the second data format, into the another information of the object metadata of the audio data in the second data format or the first data format on a basis of the second position data or the first position data obtained by the conversion by the position data generation unit.

15. The information processing apparatus according to claim 2, wherein
in a case where waveform data of a channel is included in the audio data, the position data generation unit uses information indicating a position of a speaker corresponding to the channel, as the first position data, and converts the first position data into the second position data.

16. The information processing apparatus according to claim 7, further comprising:
a rendering processing unit that performs rendering processing on a basis of object metadata of the object and waveform data for reproducing sound of the object, the object metadata including the second position data or the first position data obtained by the conversion by the position data generation unit.

17. An information processing method, comprising:
by an information processing apparatus,
acquiring speaker layout information at a time of reproduction of audio data in a first data format; and
converting first position data of a sound source in the first data format or second position data of the sound source in a second data format in which a rendering scheme at the time of reproduction is different from the first data format into the second position data or the first position data, on a basis of the speaker layout information.

18. A program for causing a computer to execute processing of:
acquiring speaker layout information at a time of reproduction of audio data in a first data format; and
converting first position data of a sound source in the first data format or second position data of the sound source in a second data format in which a rendering scheme at the time of reproduction is different from the first data format into the second position data or the first position data on a basis of the speaker layout information.
